(19) United States
(12) Patent Application Publication
(10) Pub. No.: US 2003/0090097 A1
(43) Pub. Date: May 15, 2003

(54) Stabilizing device for two-wheeler

(76) Inventor: Bernard Ranc, Fabraugues (FR)

Correspondence Address: YOUNG & THOMPSON, 745 SOUTH 23RD STREET 2ND FLOOR, ARLINGTON, VA, 22202

(21) Appl. No.: 10/168,320

(22) PCT Filed: Dec. 20, 2000
(86) PCT No.: PCT/FR00/03610

(30) Foreign Application Priority Data
Dec. 20, 1999 (FR) 99/16054

(51) Int. Cl. B60R 1/00

(52) U.S. Cl. 280/767

(57) ABSTRACT

The invention concerns a stabilising device (1) for two-wheeled vehicle (2) comprising two struts (3) for stabilising the vehicle laterally by being supported on the ground on either side thereof. The struts are articulated to a support frame (4) and are coupled to a motor mechanism, which actuates them between a support position on the ground stabilising the vehicle and a raised position, spaced away from the ground. Said motor mechanism is associated with control means connected to means indicating the vehicle speed, said control means activating the motor mechanism in a direction lowering the struts when the vehicle speed is less than a critical value below which it is hard or impossible to ensure the vehicle balance and in the lifting direction when the vehicle speed is higher than said critical value.

The present invention has for its object a stabilizing device for a two-wheeled vehicle of the motorcycle type, adapted to stabilize said vehicle when the speed of the latter becomes less than a critical value below which the equilibrium of the motorcycle becomes difficult or impossible to ensure.

It is known that the operation of motorcycles and other two-wheeled vehicles is forbidden to persons without the use of their lower members, because of the fact that when stopped or at very low speed, the driver must put his feet on the ground to ensure balance of the vehicle.

The present invention has for its object to overcome the above drawback.

To this end, the stabilizing device according to the invention, for a two-wheeled vehicle of the motorcycle type, is characterized essentially in that it comprises two stabilizing struts adapted to stabilize the vehicle laterally by bearing on the ground on opposite sides of said vehicle, said struts being articulated to a support frame and being coupled to a motor mechanism, for actuation between a lowered position bearing on the ground for stabilizing the vehicle and a raised position, spaced from the ground, said motor mechanism being associated with control means connected to means for indicating the speed of the vehicle, said control means actuating the motor mechanism in the direction to lower the struts when the speed of the vehicle indicated by the speed indicating means becomes less than a critical value below which the balance of the vehicle is difficult or impossible to ensure, and in the raising direction when the speed of the vehicle becomes greater than this critical value.

Preferably, the struts for a speed of the vehicle greater than the critical value and lower than a second predetermined value, or reference value, for example of the order of 40 km/H, are disposed in an intermediate raised position and from this second value, into a high position. The intermediate raised position which is a position according to which the struts are spaced only a small distance from the ground, permits decreasing the response time and ensures rapid stabilization in the case of abrupt slowing of the vehicle.

According to another characteristic of the invention, each strut comprises a strut arm articulated at its forward portion to the support frame and a wheel fixed at the rear of the strut arm, said wheel being adapted to come into contact with the ground.

According to another characteristic of the invention, each strut is associated with a suspension element connected on the one hand to the strut arm and on the other hand to a maneuvering lever fixed in rotation to a common transmission shaft mounted rotatably between bearings secured to the upper part of the support frame. The suspension element, when the struts are in the stabilization position, has the purpose of absorbing irregularities of the ground and maintaining the strut wheels in contact with the ground.

According to another characteristic of the invention, the motor mechanism comprises particularly a raising element connected on the one hand to the lower portion of the frame and on the other hand to one of the maneuvering levers, said raising element, by impressing a raising couple on the maneuvering lever, ensures raising of the struts.

According to another characteristic of the invention, the motor mechanism comprises moreover, at least one electric motor member comprising an output element to which is secured an actuating finger provided to act against the maneuvering lever and which impresses a swinging couple in the direction of lowering the struts, and this against the action exerted by the raising element.

According to another characteristic of the invention, the electric motor member is constituted by an electric jack articulated by its body to the lower portion of the frame, the actuating finger being carried by an actuating lever provided with a foot by which it is mounted in rotation on the transmission shaft, the electric jack, by its rod being articulated to the actuating lever.

The irreversibility of the electric jack on the one hand and the action of raising exerted continuously by the raising element, ensure the holding of the struts according to the various low, intermediate and high positions.

Other advantages and characteristics of the invention will become apparent from a reading of the description of a preferred embodiment, given by way of example, with reference to the accompanying drawings, in which:

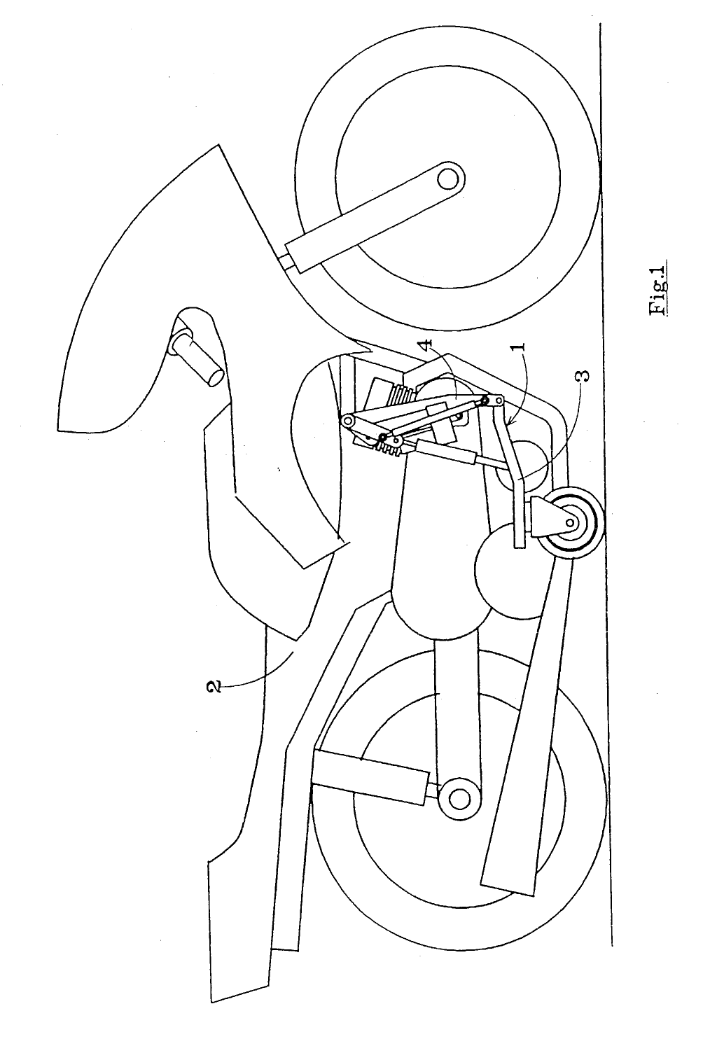

FIG. 1 is a view of a motorcycle provided with a device according to the invention.

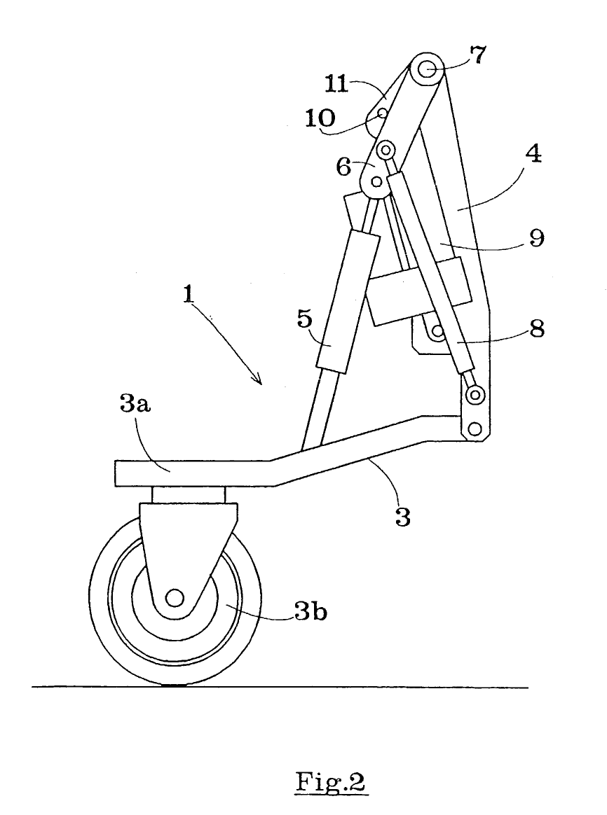

FIG. 2 is a view of a first embodiment of the device according to the invention.

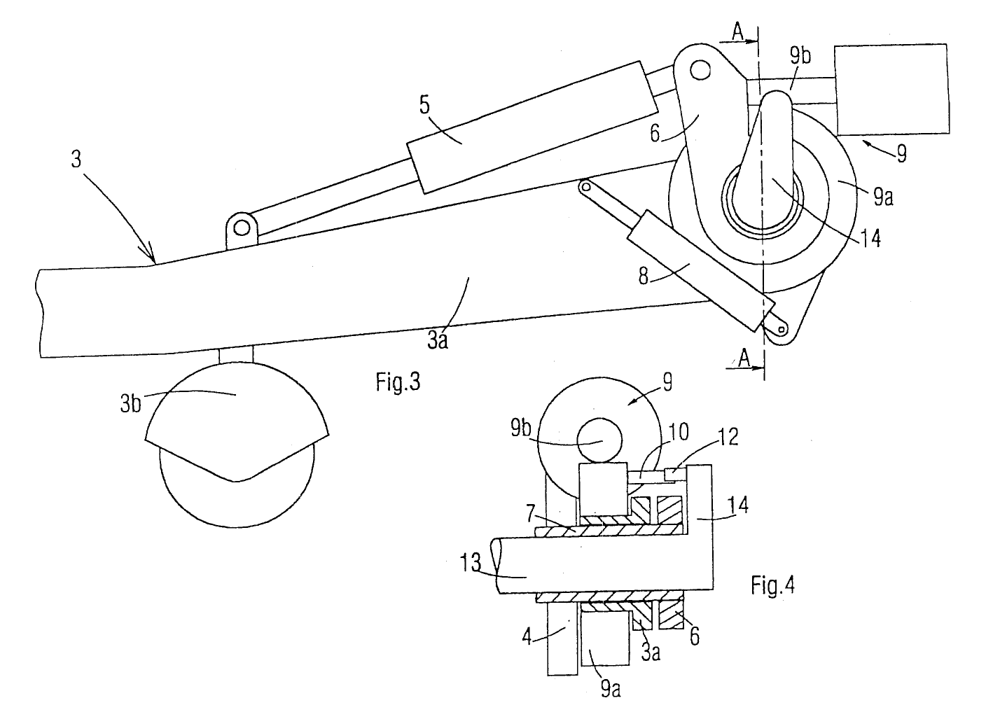

FIG. 3 is a view of a second embodiment of the device according to the invention.

FIG. 4 is a cross-sectional view on the line A-A of FIG. 3.

As shown, the stabilizing device 1 for a two-wheeled vehicle of the type of a motorcycle 2, comprises two stabilizing struts 3, namely a left strut and a right strut disposed on opposite sides of the vehicle, preferably substantially facing the intermediate region of this latter so as laterally to stabilize said vehicle by bearing on the ground on opposite sides of this latter.

The two struts 3 are articulated to a support frame 4 along a common geometrical axis, perpendicular to the direction of movement of the vehicle. The support frame 4 can be a frame connected to the front of the vehicle and fixed on the chassis of the vehicle or else the chassis of the vehicle 2 if this latter can be provided for this purpose.

As a modification, the stabilizing device will be mounted to the rear of the vehicle.

The two struts 3 are coupled to a motor mechanism, for actuation between a lowered position bearing on the ground for stabilization of the vehicle and a raised position, spaced from the ground, said motor mechanism being associated with control means connected to means for indicating the speed of the vehicle (not shown). The control means (not shown) actuate the motor mechanism in the direction of lowering the struts 3 when the speed of the vehicle indicated by the speed indicating means becomes less than a critical value below which the balance of the vehicle 2 is difficult or impossible to ensure, and actuating the motor mechanism in a raising direction when the speed of the vehicle 2 becomes greater than this critical value. Preferably, two upper positions are provided, namely a greatest height position and an intermediate height position.

The struts 3 are brought into and held in the intermediate upper position when the speed of the vehicle 2 is greater than the critical value and less than or equal to a second predetermined reference value, of the order of 40 Km/h for example, and are brought and held into the extreme upper position when the speed of the vehicle is greater than this second reference value.

According to a preferred embodiment, each strut 3 comprises a strut arm 3a articulated at its front portion to a bearing secured to the support frame 4 and an omni-directional wheel 3b fixed to the rear end of the strut arm 3a, said wheel 3b being adapted to come into contact with the ground. The strut arm 3a has an upper flat surface constituting a footrest and forming a pedal. This arm can be constituted by a casing structure for lowering its weight and imparting high mechanical strength.

Each strut 3 is associated with a suspension element 5 connected on the one hand to the strut arm 3a and on the other hand to a maneuvering lever 6 fixed rotatably and translatably to a horizontal transmission shaft 7, perpendicular to the direction of movement of the vehicle, mounted rotatably in bearings secured to the upper portion of the support frame 4. The transmission shaft is common to the two struts 3 for reasons which will become apparent later.

According to the preferred embodiment, the suspension element 5 is constituted by a gas spring of the type of those comprising a cylindrical body on which is formed a cylindrical bore receiving slidably a piston with a rod, said piston with the bore defining a working chamber in which is trapped a volume of gas under pressure. This gas spring 5 is articulated by its rod to the strut 3 and by its body to the maneuvering lever 6. The two gas suspension springs have the purpose of maintaining the wheels 3b of the struts bearing against the ground by compensating for irregularities which this latter can have.

As a suspension element 5 can also be used a suspension shock absorber combination of known type.

According to the preferred embodiment, a motor mechanism is associated with each strut 3.

Each motor mechanism comprises particularly a raising element 8 connected on the one hand to the lower portion of the support frame 4 and on the other hand to one of the maneuvering levers 6, said raising element 8, by impressing a raising force on one of the maneuvering levers 6, ensures raising the two struts 3, the raising movement being transmitted from one to the other by the transmission shaft 7.

Preferably, the raising element is constituted by a spring. This raising spring is constituted by a gas spring of the type of those including a cylindrical body in which is formed a cylindrical bore in which slides a piston with a rod, said piston with the bore defining a working chamber in which is trapped a body of gas under pressure, the gas spring being articulated by its rod to the lower portion of the chassis and by its body to the maneuvering lever.

Moreover, the motor mechanism comprises an electric motor member 9 comprising an output shaft to which is secured an actuating finger 10 adapted to act on the maneuvering lever 6, more precisely on the upper surface of this latter, and imparting to it a swinging couple in the direction of lowering the struts 3 and this against the action exerted by the raising element.

According to a preferred embodiment, the electric motor member 6 is constituted by an electric jack articulated by its body to the lower portion of the frame, the actuating finger 10 being carried by an actuating lever 11 provided with a foot by which it is mounted rotatably on the transmission shaft 7, the electric jack 9, by its rod, being articulated to the actuating lever 11.

With the rod of this jack or with one of the movable members of this latter, are associated position detectors, for respectively the low position, the intermediate high position and the extreme high position of each strut. This position detectors, known per se, are electrically connected to the control means.

The configuration as described, combined with the presence of two motor mechanisms for actuating the struts 3, is particularly interesting. Thus, in the case of failure of an electric jack 9 of one of these mechanisms, in the upper position, the lowering or the raising of the jacks 3 will still be ensured by the other mechanism because of the kinematic connection of the struts with each other thanks to the transmission shaft, the maneuvering levers and the suspension elements. In case of failure of one of the electric jacks 9 in the lower position, the struts remain in position to stabilize the vehicle. It will be seen that these arrangements greatly improve the safety of the vehicle and render the latter usable by handicapped persons who do not have the use of their lower members.

As mentioned above, the motor mechanisms, more precisely the electric jacks 9 of these latter, are controlled by control means comprising a power interface by which electric power is transmitted to the electric jacks. With these control means, known per se, is connected the indicator means of the speed, constituted preferably by a speed detector of the type of those adapted for example to deliver an electric signal of an intensity proportional to the speed of the vehicle. The control means could be provided with a comparator circuit to compare the value of this signal to the various reference values. As a function of the result of these comparisons, the control means correspondingly control the electric jacks.

The electric jacks 9 are supplied by a secondary battery independent of the principal battery of the vehicle. In case of failure of the secondary battery, the principal battery will be connected, by control means on the supply circuit of these jacks 9. Moreover, in case of failure of the principal battery, the vehicle will be immobilized, a secondary battery not being able to be used for operation of the vehicle.

There has previously been described a stabilizing device whose shaft 7 is parallel and spaced in height from the geometric axis of articulation of the stabilizing struts 3. According to another arrangement of the invention, the shaft 7 is secured to the lower portion of the support frame 4 and constitutes the pivot shaft for the struts 3, and in this case the shaft 7 occupies a lower position. According to this arrangement, each motor member could be constituted by a system with a toothed wheel and an endless screw, said endless screw being in engagement with the rotatable output shaft of an electric motor fixed to the frame of the vehicle, said wheel being mounted rotatably on the shaft 7 and being provided with the actuating finger 10.

In FIG. 3 is shown another embodiment of the device according to the invention. According to this embodiment, the device again comprises two motor members 9. Again according to this embodiment, the shaft 7 is fixed in rotation and translation to the support frame 4 and each maneuvering lever 6 is mounted rotatably on said shaft 7. This shaft 7 will be fixed to the frame 4 of the vehicle and will preferably constitute the articulation shaft of the struts 3.

Each motor member 9, as previously indicated, will be constituted by a system with a toothed wheel 9a and an endless screw 9b engaged with each other and providing an irreversible transmission. The screw 9b is in engagement with the rotatable output shaft of an electric motor fixed to the frame 4 of the vehicle. The wheel 9a will be mounted rotatably on the shaft 7 and will be provided with the finger 10 to bear against the maneuvering lever 6.

According to this embodiment, the finger 10 does not act by pressing directly on the lever 6 but via a pin 12 secured to a mechanism for the transmission of the movement from one lever 6 to the other, this mechanism comprising a rotatable transmission shaft 13 mounted rotatably in the shaft 7, this latter, for this purpose, comprising an internal through bore. The transmission mechanism comprises at the ends of the shaft 13 two radial levers 14 each bearing a pin 12 acting directly by pressing on the corresponding maneuvering lever 6. Each pin 12 receives the pressure of the corresponding finger 10.

As previously indicated, the configuration with two motors and transmission mechanisms, permits in the case of breakdown of one of the electric motors in the upper position, the maneuvering of the struts by means of the other motor. The breakdown of one of the motors in the lower position prevents raising the struts.

With the endless wheel 9a will be associated position detectors for respectively the low position, the intermediate height position and the extreme height position of each strut. These position detectors, known per se, are electrically connected to the control means.

The stabilizing device as described can be used on any type of two-wheel vehicle, motorized or not, and permits the use of these vehicles by persons deprived of the use of their lower members. Moreover, this device avoids tilting of the vehicle when the driver mounts or dismounts from this latter.

It follows that the present invention can be the subject of all modifications and variations in the field of technical equivalents without thereby departing from the scope of the present claims.

1. Stabilizing device (1) for two-wheel vehicles (2) characterized in that it comprises two stabilizing struts (3) adapted laterally to stabilize the vehicle by bearing on the ground on opposite sides of said vehicle (2), said struts being articulated to a support frame (4) and being coupled to a motor mechanism for actuation between a lowered position bearing on the ground for stabilization of the vehicle and a raised position, spaced from the ground, said motor mechanism being associated with control means connected to an indicator means for the speed of the vehicle, said control means actuating the motor mechanism in the direction to lower the struts when the speed of the vehicle indicated by the speed indicator means becomes less than a critical value below which the balance of the vehicle is difficult or impossible to ensure, and in the raising direction when the speed of the vehicle becomes greater than this critical value.

2. Stabilizing device (1) according to claim 1, characterized in that the frame (4) to which are articulated the struts (3) is a chassis fixed to the chassis of the vehicle.

3. Stabilizing device according to claim 1 or claim 2, characterized in that each strut (3) is articulated to the support frame about an axis perpendicular to the direction of movement of the vehicle.

4. Stabilizing device according to any one of the preceding claims, characterized in that each strut (3) comprises a strut arm (3a) articulated by its front portion to the support frame (4) and a wheel (3b) fixed to the rear end of the strut arm (3a), said wheel (3b) being adapted to come into contact with the ground.

5. Stabilizing device according to any one of the preceding claims, characterized in that each strut (3) is associated with a suspension element (5) connected on the one hand to the strut arm (3a) and on the other hand to a maneuvering lever (6) secured to a common horizontal shaft (7) perpendicular to the direction of movement of the vehicle, said shaft being secured to the support frame (4).

6. Stabilizing device according to claim 5, characterized in that the maneuvering lever (6) is fixed in rotation to the shaft (7), this latter being mounted rotatably in bearings secured to the support frame (4).

7. Stabilizing device according to claim 6, characterized in that the shaft (7) is secured to the upper portion of the support frame (4).

8. Stabilizing device according to claim 7, characterized by the fact that the shaft (7) is secured to the lower portion of the support frame (4) and constitutes the articulation shaft of the struts (3).

9. Stabilizing device according to claim 5, characterized in that the shaft 7 is fixed in rotation and translation to the support frame (4) and each maneuvering lever (6) is mounted rotatably on said shaft (7).

10. Stabilizing device according to any one of claims 5 to 9, characterized in that the motor mechanism also comprises at least one electric motor member (9) comprising an output element to which is secured an actuating finger (10) provided to act on the maneuvering lever (6) and imparting to it a swinging couple in the direction of lowering the struts (3) and this against the action exerted by the raising element (8).

11. Stabilizing device according to claim 10, characterized in that the electric motor member (9) is constituted by an electric jack articulated by its body to the lower portion of the frame (4), the actuating finger (10) being carried by an actuating lever (11), provided with a foot by which it is mounted rotatably on the transmission shaft (7), the electric jack (9), by its rod being articulated to the actuating lever (11).

12. Stabilizing device according to claim 10, characterized in that each motor member (9) is constituted by a system with a toothed wheel (9a) and an endless screw (9b), engaged with each other, said screw (9b) being in engagement with the rotatable output shaft of an electric motor fixed to the frame (4) of the vehicle and said wheel (9a) being mounted rotatably on the shaft (7) and being provided with an actuating finger (10) to press against one of the maneuvering levers (6) by means of a pin (12) secured to a mechanism for transmission of the movement of one lever (6) to the other, this mechanism comprising a rotatable transmission shaft (13) mounted rotatably in the shaft (7), this latter, for this purpose, comprising an internal through bore, said transmission mechanism comprising at the ends of the shaft (13) two radial levers (14) each carrying a pin (12) acting directly by pressing on the corresponding maneuvering lever (6), each of said pins (12) receiving the pressure of the corresponding finger (10).

13. Stabilizing device according to any one of claims 5 to 12, characterized in that the actuating mechanism comprises particularly a raising element (8) connected on the one hand to the lower portion of the frame (4) and on the other hand to one of the maneuvering levers (6), said raising element (8), by imparting a lifting couple to the maneuvering lever (6), ensuring the raising of the struts (3).

14. Stabilizing device according to claim 13, characterized in that the lifting element (8) is constituted by a spring.

15. Stabilizing device according to claim 14, characterized in that the lifting spring (8) is constituted by a gas spring of the type of those comprising a cylindrical body in which is formed a cylindrical bore in which slides a piston with a rod, said piston with the bore defining a working chamber in which is trapped a body of gas under pressure, the gas spring being articulated by its rod to the lower portion of the frame (4) and by its body to the maneuvering lever (6).

16. Stabilizing device according to any one of the preceding claims, characterized in that the indicator means for the speed of the vehicle is a speed detector adapted to deliver an electrical speed whose intensity is proportionate to the speed of the vehicle.

17. Stabilizing device according to any one of the preceding claims, characterized in that with each strut (3) is associated a motor mechanism.

18. Stabilizing device according to claim 4, characterized in that each arm (3a) of a strut (3) is arranged as a footrest.

19. Stabilizing device according to any one of the preceding claims, characterized in that there are provided two upper positions for the struts (3), namely an extreme upper position and an intermediate upper position, the struts (3) are provided and held in intermediate upper position when the speed of the vehicle (2) is greater than the critical value and less than or equal to a second predetermined reference value, and are brought and held to the extreme upper position when the speed of the vehicle is greater than this second reference value.
